(19) United States
(12) Patent Application Publication
(10) Pub. No.: US 2015/0358717 A1
(43) Pub. Date: Dec. 10, 2015

(54) Audio Headset for Alerting User to Nearby People and Objects

(71) Applicant: Plantronics, Inc., Santa Cruz, CA (US)

(72) Inventors: Timothy P. Johnston, Los Gatos, CA (US); Joe Burton, Los Gatos, CA (US); Shantanu Sarkar, San Jose, CA (US)

(73) Assignee: PLANTRONICS, INC., Santa Cruz, CA (US)

(21) Appl. No.: 14/298,754

(22) Filed: Jun. 6, 2014

(51) Int. Cl. H04R 1/10

(52) U.S. Cl. CPC H04R 1/1091; H04R 2499/11

(57) ABSTRACT

Apparatus having corresponding methods and computer-readable media comprise: an earpiece; an acoustic transducer configured to generate an acoustic wave external to the earpiece; an acoustic sensor; a speaker disposed internal to the earpiece; and a processor configured to cause the headset to provide an alert responsive to the acoustic sensor receiving a reflection of the acoustic wave.

### FIELD

The present disclosure relates generally to the field of audio headsets. More particularly, the present disclosure relates to alerting a headset user to nearby people or objects.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Headsets and headphones that reduce external noise or sound reaching the user's ear are popular for working, exercising, or just sitting on a park bench. This noise reduction may be active or passive. With passive noise reduction, a solid barrier reduces the level of external noise reaching the ear. Nearly every headset or headphone achieves passive noise reduction to some extent. With active noise control, a second sound is generated that, when added to the external noise, cancels that noise.

However, external sound may include not only annoying noises that are desirable to block, but also useful information. For example, the headset user may not be aware that a nearby friend or colleague is speaking. As another example, the headset user may not be aware that an attacker is approaching. This isolation limits the user's ability to respond to a coworker approaching, take action to be more approachable, or to prepare for an approaching stranger.

Previous solutions have included adding buttons to the headset that allow the user to keep the headset in place and “open the mic,” thereby allowing external noise to be picked up by the outward-facing microphone and introduced through the receive channel to the internal speaker. However, this approach requires action by the user, and fails to alert the user to the presence of others. Other approaches include allowing a significant “leakage” of the external noise into the headset. However, this approach results in a less immersive user experience.

### SUMMARY

In general, in one aspect, an embodiment features apparatus comprising: an earpiece; an acoustic transducer configured to generate an acoustic wave external to the earpiece; an acoustic sensor; a speaker disposed internal to the earpiece; and a processor configured to cause the headset to provide an alert responsive to the acoustic sensor receiving a reflection of the acoustic wave.

Embodiments of the apparatus can include one or more of the following features. In some embodiments, a headset comprises the apparatus. In some embodiments, the processor is further configured to generate one or more parameters representing at least one of i) a distance to a reflector of the acoustic wave, ii) a velocity of the reflector of the acoustic wave, iii) an acceleration of the reflector of the acoustic wave, and iv) a direction to the reflector of the acoustic wave; and the processor is further configured to cause the apparatus to provide the alert only responsive to the one or more parameters meeting selected criteria. In some embodiments, to provide the alert, the processor is further configured to cause the speaker to generate an audible message. In some embodiments, the processor is further configured to apply active noise reduction to audio provided to the speaker; and to provide the alert, the processor is further configured to modify the active noise reduction. Some embodiments comprise a microphone configured to generate audio; wherein, to provide the alert, the processor is further configured to provide the audio to the speaker. Some embodiments comprise a port configured to allow sound into the earpiece when open, and to block sound from passing into the earpiece when closed; wherein, to provide the alert, the processor is configured to cause the port to open. Some embodiments comprise a microphone configured to generate audio; wherein the processor is further configured to provide the alert responsive to the audio meeting selected criteria, wherein the selected criteria includes at least one of i) whether the audio represents speech, and ii) whether the audio represents a spoken selected keyword.

In general, in one aspect, an embodiment features a method comprising: generating, at a headset, an acoustic wave external to the headset; and providing an alert to a user of the headset responsive to receiving a reflection of the acoustic wave.

Embodiments of the method can include one or more of the following features. Some embodiments comprise generating one or more parameters representing at least one of i) a distance to a reflector of the acoustic wave, ii) a velocity of the reflector of the acoustic wave, iii) an acceleration of the reflector of the acoustic wave, and iv) a direction to the reflector of the acoustic wave; and providing the alert only responsive to the one or more parameters meeting selected criteria. Some embodiments comprise generating an audible message. Some embodiments comprise modifying active noise reduction applied to audio provided to a speaker of the headset. Some embodiments comprise providing, to a speaker of the headset, audio generated by a microphone of the headset. Some embodiments comprise opening a port of the headset, wherein the port allows sound into an earpiece of the headset when open.

In general, in one aspect, an embodiment features computer-readable media embodying instructions executable by a computer to perform functions comprising: causing an acoustic transducer to generate an acoustic wave external to a headset; and providing an alert to a user of the headset responsive to an acoustic sensor of the headset receiving a reflection of the acoustic wave.

Embodiments of the computer-readable media can include one or more of the following features. In some embodiments, the functions further comprise: generating one or more parameters representing at least one of i) a distance to a reflector of the acoustic wave, ii) a velocity of the reflector of the acoustic wave, iii) an acceleration of the reflector of the acoustic wave, and iv) a direction to the reflector of the acoustic wave; and providing the alert only responsive to the one or more parameters meeting selected criteria. In some embodiments, the functions further comprise: causing a speaker of the headset to generate an audible message. In some embodiments, the functions further comprise: modifying active noise reduction applied to audio provided to a speaker of the headset. In some embodiments, the functions further comprise: providing, to a speaker of the headset, audio generated by a microphone of the headset. In some embodiments, the functions further comprise: causing a port of the headset to open, wherein the port allows sound into an earpiece of the headset when open.

The details of one or more implementations are set forth in the accompanying drawings and the description below. Other features will be apparent from the description and drawings, and from the claims.

### DESCRIPTION OF DRAWINGS

FIG. 1 shows elements of a communication system according to some embodiments of the present disclosure.

FIG. 2 shows elements of a smartphone according to some embodiments.

FIG. 3 shows elements of a headset according to an embodiment that employs active sonar to detect people and objects.

FIG. 4 shows a process for the headset of FIG. 3 according to one embodiment.

FIG. 5 shows elements of a headset according to an embodiment that employs speech to detect people.

FIG. 6 shows a process for the headset of FIG. 5 according to one embodiment.

The leading digit(s) of each reference numeral used in this specification indicates the number of the drawing in which the reference numeral first appears.

### DETAILED DESCRIPTION

Embodiments of the present disclosure provide communication systems, headphones and headsets that alert the user to nearby people and objects. In the remainder of this description, the term “headset” is used to include both headsets, which generally include a microphone, and headphones, which generally do not. In the described embodiments, an acoustic transducer generates an acoustic wave external to an earpiece of the headset, and an acoustic sensor detects reflections of the acoustic wave. The acoustic wave may be in the audible range, but is preferably in the ultrasonic range to avoid annoying the user and others, and to take advantage of the superior directionality of ultrasonic signals.

When a reflection of the acoustic wave is detected, the headset provides an alert to the user. In some embodiments, the headset provides the alert only under certain conditions, for example, when the distance to a reflector of the acoustic wave is less than a selected distance, when the velocity of the reflector exceeds a selected velocity, when the acceleration of the reflector exceeds a selected acceleration, when the direction to the reflector is within a selected angular range, or the like, or any combination thereof. In some embodiments, the headset may include an accelerometer to compensate for motion of the user. In other embodiments, other techniques may be employed to compensate for user motion, for example such as geolocation through GPS or cell tower ranging or the like.

In some embodiments, the alert may be provided when a spoken keyword is detected in the external noise. For example, the keyword may be the user's name or the word “hello” and similar words.

The alert may take any form. For example, the speaker in the headset may generate an audible message. For example, in a headset featuring active noise reduction, the headset may modify the active noise reduction, thereby making external sounds more prominent for the user. In a headset having a microphone, the microphone may be “opened,” thereby passing sound received by the microphone to the headset speaker. For example, in a headset that includes a physical port to pass sound into the earpiece when open, and to block sound from the earpiece when closed, the port may be opened.

Other features are contemplated as well.

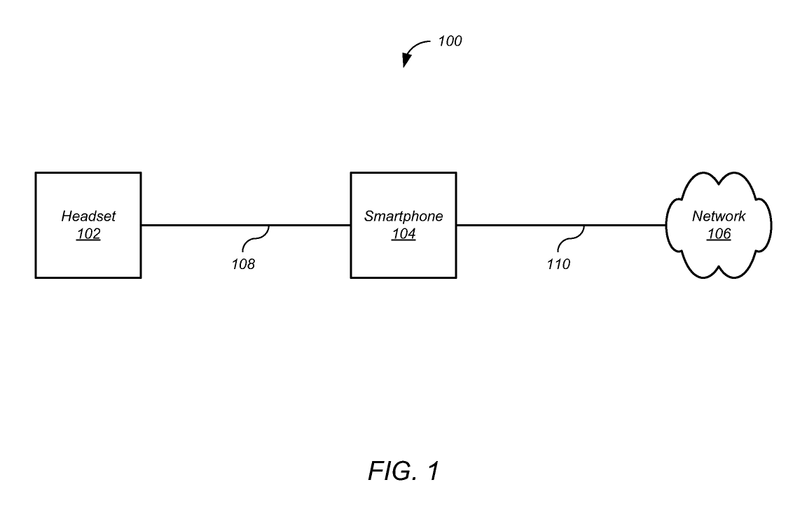

FIG. 1 shows elements of a communication system 100 according to some embodiments of the present disclosure. Although in the described embodiments, the elements of the communication system 100 are presented in one arrangement, other embodiments may feature other arrangements, as will be apparent to one skilled in the relevant arts based on the disclosure and teachings provided herein. For example, the elements of the communication system 100 may be implemented in hardware, software, or combinations thereof.

Referring now to FIG. 1, the communication system 100 includes a headset 102, a smartphone 104, and a network 106. In other embodiments, the smartphone 104 may be replaced by a feature phone, a desk phone, a softphone, a computer, and the like. The network 106 may be a mobile network, a computer network or the like. The headset 102 and the smartphone 104 may communicate over a channel 108 such as a wireless link, a wired link, or the like. The wireless link may be a Bluetooth link, a Digital Enhanced Cordless Telecommunications (DECT) link, a WiFi link, or the like. The smartphone 104 and the network 106 may communicate over a channel 110. The headset 102 may exchange audio, status messages, command messages, and the like with the smartphone 104 over the channel 108. The smartphone 104 may exchange audio, status messages, and command messages with the network 106 over the channel 110.

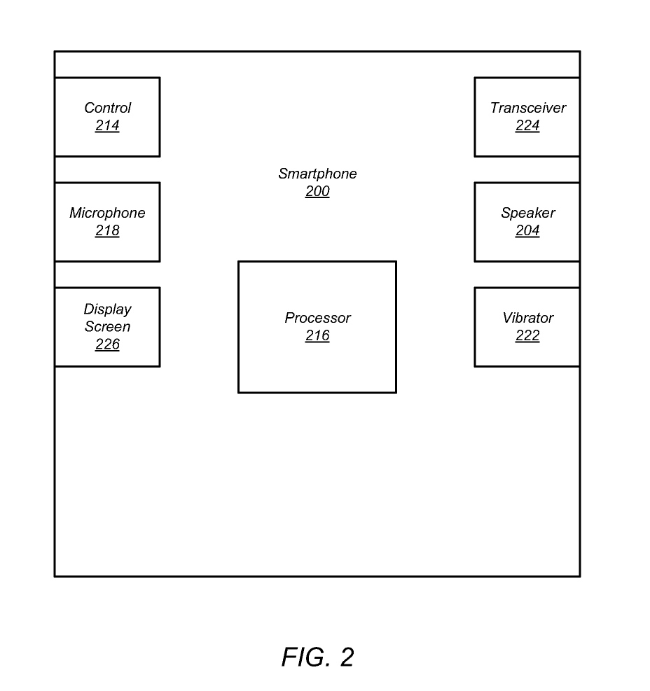

FIG. 2 shows elements of a smartphone 200 according to some embodiments. The smartphone 200 may be used as the smartphone 104 of FIG. 1. Although in the described embodiment elements of the smartphone 200 are presented in one arrangement, other embodiments may feature other arrangements. For example, elements of the smartphone 200 may be implemented in hardware, software, or combinations thereof.

Referring to FIG. 2, the smartphone 200 may include a speaker 204, a control 214, a processor 216, a microphone 218, a vibrator 222, a transceiver 224, and a display screen 226. The control 214 may be implemented as a touchscreen, user-operable buttons, or the like. Any function implemented by the control 214 may be implemented by voice command or the like.

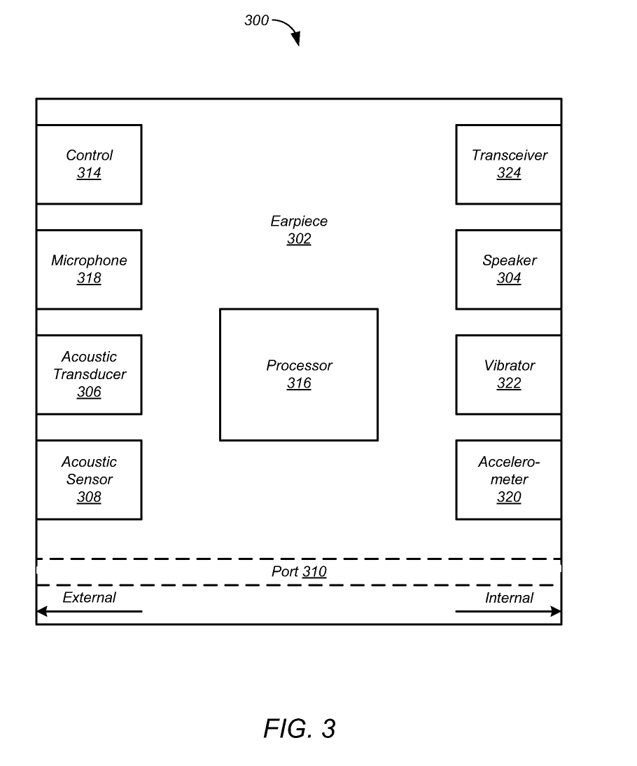

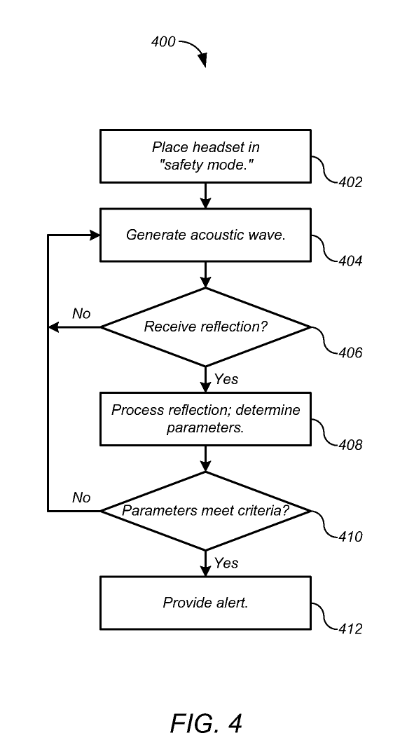

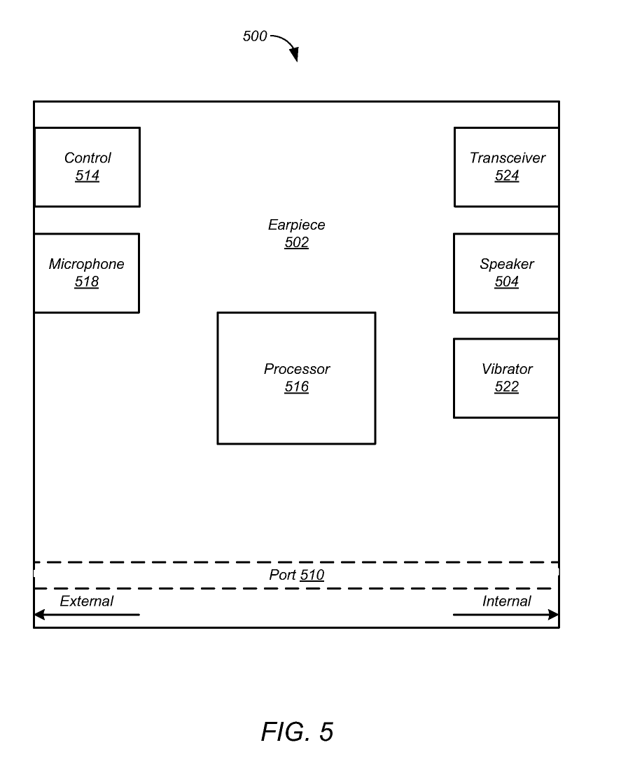

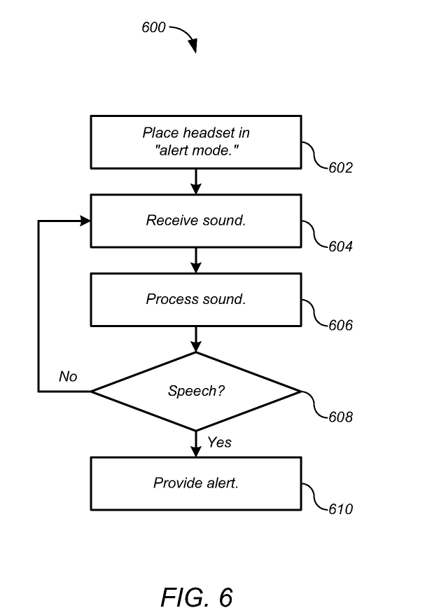

FIG. 3 shows elements of a headset 300 according to an embodiment that employs active sonar to detect people and objects. The headset 300 may be used as the headset 102 of FIG. 1. Although in the described embodiment elements of the headset 300 are presented in one arrangement, other embodiments may feature other arrangements. For example, elements of headset 300 may be implemented in hardware, software, or combinations thereof. As another example, various elements of the headset 300 may be implemented as one or more digital signal processors. Elements of the embodiment of FIGS. 3 and 4 may be combined with elements of the embodiment of FIGS. 5 and 6.

Referring to FIG. 3, the headset 300 may include an earpiece 302. The earpiece 302 may include a speaker 304, an acoustic transducer 306, an acoustic sensor 308, a port 310, a control 314, and a processor 316. The processor 316 may include analog-to-digital converters, digital-to-analog converters, digital signal processors, and the like. The earpiece 302 may also include a microphone 318. The earpiece 302 may also include an accelerometer 320. The earpiece 302 may also include a vibrator 322. The earpiece 302 may also include a transceiver 324. In other embodiments, one or more of these elements may be located in other parts of the headset 300.

The speaker 304 is disposed internal to the earpiece 302 such that the earpiece 302 provides some passive noise reduction. That is, the earpiece 302 physically blocks external noise, that is, noise external to the earpiece 302. The acoustic transducer 306, the acoustic sensor 308, and the microphone 318 are disposed external to the earpiece 302. The port 310 allows external sound to pass into the earpiece 302 when open, and blocks external sound from passing into the earpiece 302 when closed. The control 314 may be implemented as a user-operable button, slide switch, or the like. The control 314 may be employed by the user to control the functionality of the headset 300. For example, the user may employ the control 314 to prevent the alerts from being issued, for example when the user is in a location where safety is not a concern. As another example, the user may employ the control 314 to change the types of alert issued. Any function implemented by the control 314 may be implemented by voice command.

FIG. 4 shows a process 400 for the headset 300 of FIG. 3 according to one embodiment. Although in the described embodiments the elements of process 400 are presented in one arrangement, other embodiments may feature other arrangements. For example, in various embodiments, some or all of the elements of process 400 may be executed in a different order, concurrently, and the like. Also some elements of process 400 may not be performed, and may not be executed immediately after each other. In addition, some or all of the elements of process 400 may be performed automatically, that is, without human intervention.

Referring to FIG. 4, at 402, a user of the headset 300 may employ the control 314 to place the headset 300 in a “safety mode.” In the “safety mode,” the headset 300 may provide alerts to the user responsive to detecting nearby people and objects. At 404, the acoustic transducer 306 may generate an acoustic wave. For example, the acoustic transducer 306 may generate an ultrasonic signal. The acoustic wave may take any form, such as tones, chirps or the like. If the acoustic sensor 308 receives a reflection of the acoustic wave, at 406, then the processor 316 may process the reflection, at 408. That is, the processor 316 generates one or more parameters based on data generated by the acoustic sensor 308 that represents the reflection. The examples presented now are intended to be illustrative, not limiting. The processor 316 may determine a distance to a reflector of the acoustic wave based on an elapsed time between transmitting the acoustic wave and receiving the corresponding reflection. The processor 316 may determine a closing velocity and/or closing acceleration of the reflector using Doppler techniques or the like. In implementations having more than one acoustic sensor 308, the processor may determine a direction of the reflector using time difference of arrival techniques or the like. The processor 316 may determine other parameters instead of, or in addition to, the examples listed above. The processor 316 may employ data provided by the accelerometer 320 in determining these and other parameters. For example, the processor may employ the accelerometer data to compensate for motion of the headset 300, that is, the motion of the user.

At 410, The processor 316 may determine whether the determined parameters meet selected criteria. If the criteria are met, at 412, the processor 316 may cause the headset 300 to provide an alert, at 414. For example, the criteria may specify that the alert should be provided when the reflector is within 20 feet of the headset 300, is located behind the headset 300, and is approaching the headset 300 at a speed exceeding 5 miles per hour. Such criteria could alert the user to a possible attacker approaching from the rear. Of course other criteria may be used. The headset 300 may provide the alert in any manner. In some embodiments, the processor 316 may cause the speaker 304 to generate an audible message. The message may indicate the criteria met by the determined parameters. For example, the message may state that a person is approaching from behind. In headsets 300 where the processor 316 applies active noise reduction, the processor 316 may modify the active noise reduction, thereby allowing more external sound to reach the user's ears. For example, the processor 316 may reduce the overall level of active noise reduction. As another example, the processor 316 may reduce the level of active noise reduction in the voice band only, for example to pass only frequencies above 400 Hz. In headsets 300 having a microphone 318 the processor 316 may provide the microphone audio to the speaker 304, thereby allowing external sound to reach the user's ears. In such embodiments, the microphone audio may be processed before reaching the speaker 304, for example to remove background noise. In headsets 300 having a port 310, the processor 316 may cause the port 310 to open, thereby allowing more external sound to reach the user's ears. In some embodiments, the processor 316 may cause the vibrator 322 to vibrate. The processor 316 may reduce a volume of music or other audio being played. The above types of alert, as well as other types of alert, may be used alone or in combination. In some embodiments, the alert may differ based on the location or activity of the user. For example, the headset 300 may reduce volume when someone is approaching from behind when at the office, or provide a more intrusive alert when someone is approaching very quickly from behind when the user is on the running trail at night.

In other embodiments, some of the functions performed by the headset 300 may be performed by the smartphone 200. The transceiver 324 of the headset 300 may transmit raw data to the transceiver 224 of the smartphone 200. The processor 216 of the smartphone 200 may determine the parameters based on the raw data. The smartphone 200 may transfer the parameters to the headset 300. The transceiver 324 of the headset 300 may transmit the parameters to the transceiver 224 of the smartphone 200. The processor 216 of the smartphone 200 may determine whether the parameters meet the selected criteria. The processor 216 may cause the smartphone 200 to provide an alert, for example using the display screen 226, the speaker 204, and/or the vibrator 222. The user may configure these alerts using the control 214. The smartphone 200 may cause the headset 300 to provide the alert.

FIG. 5 shows elements of a headset 500 according to an embodiment that employs speech to detect people. The headset 500 may be used as the headset 102 of FIG. 1. Although in the described embodiment elements of the headset 500 are presented in one arrangement, other embodiments may feature other arrangements. For example, elements of headset 500 may be implemented in hardware, software, or combinations thereof. As another example, various elements of the headset 500 may be implemented as one or more digital signal processors.

Referring to FIG. 5, the headset 500 may include an earpiece 502. The earpiece 502 may include a speaker 504, a port 510, a control 514, and a processor 516. The processor 516 may include analog-to-digital converters, digital-to-analog converters, digital signal processors, and the like. The earpiece 502 may also include a microphone 518. The earpiece 502 may also include a vibrator 522. The earpiece 502 may also include a transceiver 524. In other embodiments, one or more of these elements may be located in other parts of the headset 500.

The speaker 504 is disposed internal to the earpiece 502 such that the earpiece 502 provides some passive noise reduction. That is, the earpiece 502 physically blocks external noise, that is, noise external to the earpiece 502. The microphone 518 is disposed external to the earpiece 502. The port 510 allows external sound to pass into the earpiece 502 when open, and blocks external sound from passing into the earpiece 502 when closed. The control 314 may be implemented as a user-operable button, slide switch, or the like. The control 514 may be employed by the user to control the functionality of the headset 500. For example, the user may employ the control 514 to prevent the alerts from being issued, for example when the user wishes not to be disturbed. As another example, the user may employ the control 514 to change the types of alert issued. Any function implemented by the control 514 may be implemented by voice command.

FIG. 6 shows a process 600 for the headset 500 of FIG. 5 according to one embodiment. Although in the described embodiments the elements of process 600 are presented in one arrangement, other embodiments may feature other arrangements. For example, in various embodiments, some or all of the elements of process 600 may be executed in a different order, concurrently, and the like. Also some elements of process 600 may not be performed, and may not be executed immediately after each other. In addition, some or all of the elements of process 600 may be performed automatically, that is, without human intervention. Elements of the embodiment of FIGS. 5 and 6 may be combined with elements of the embodiment of FIGS. 3 and 4.

Referring to FIG. 6, at 602, a user of the headset 500 may employ the control 514 to place the headset 500 in an “alert mode.” In the “alert mode,” the headset 500 may provide alerts to the user responsive to detecting speech of persons other than the user. At 604, the microphone 518 may receive sound. At 606, the processor 516 may process the sound. That is, the processor 516 may process audio generated by the microphone 518 responsive to receiving the sound. If the audio represents speech, at 608, the processor 516 may cause the headset 500 to provide an alert, at 610.

The processor 516 may detect speech in the audio in any manner. For example, the processor 516 may require a certain sound pressure in a certain amount in a certain band for a certain time (e.g., 60 db between 800 Hz and 2 KHz for 300 ms). In some embodiments, the processor 516 may cause the headset 500 to provide an alert only when the speech is that of a person other than the user. The processor 516 may determine the speech is that of a person other than the user in any manner. For example, the processor 516 may employ characteristics of the audio such as amplitude, techniques such as near/far detection, and the like to distinguish speech of the user from speech of others. For example, in a headset 500 having multiple microphones 518, detecting sound in the speech band with significantly higher sound pressure on one of the microphones 518 may indicate a person to one side of the user. The indicated side may be announced to the user by the headset 500. For example, the processor 516 may learn the speech of the user over time when not in the “alert mode,” and may use that knowledge in “alert mode” to distinguish speech of the user from speech of others. In some embodiments, the processor 516 may cause the headset 500 to provide an alert only when the speech includes one or more selected keywords. For example, the keywords may include words such as “hi,” “hello,” and the like, as well as the user's name.

The headset 500 may provide the alert in any manner. In some embodiments, the processor 516 may cause the speaker 504 to generate an audible message. In headsets 500 where the processor 516 applies active noise reduction, the processor 516 may modify the active noise reduction, thereby allowing the speech to reach the user's ears. For example, the processor 516 may reduce the level of active noise reduction. As another example, the processor 316 may reduce the level of active noise reduction in the voice band only, for example to pass only frequencies above 400 Hz. The processor 516 may provide the microphone audio to the speaker 504, thereby allowing the speech to reach the user's ears. In such embodiments, the microphone audio may be processed before reaching the speaker 504, for example to remove background noise. In headsets 500 having a port 510, the processor 516 may cause the port 510 to open, thereby allowing the speech to reach the user's ears. In some embodiments, the processor 516 may cause the vibrator 522 to vibrate. In some embodiments, the processor 516 may cause the headset 500 to pass the speech to the user's ear automatically. In other embodiments, the processor 516 may prompt the user to operate the control 514 to pass the speech to the user's ear. In various embodiments, the prompt and/or the control 514 may be implemented in the headset 500 or in another device, such as a computer, smartphone, or the like. The processor 516 may reduce a volume of music or other audio being played. The above types of alert, as well as other types of alert, may be used alone or in combination.

In other embodiments, some of the functions performed by the headset 500 may be performed by the smartphone 200. The transceiver 524 of the headset 500 may transmit raw data to the transceiver 224 of the smartphone 200. The processor 216 of the smartphone 200 may determine the parameters based on the raw data. The smartphone 200 may transfer the parameters to the headset 500. The transceiver 524 of the headset 500 may transmit the parameters to the transceiver 224 of the smartphone 200. The processor 216 of the smartphone 200 may determine whether the parameters meet the selected criteria. The processor 216 may cause the smartphone 200 to provide an alert, for example using the display screen 226, the speaker 204, and/or the vibrator 222. The user may configure these alerts using the control 214. The smartphone 200 may cause the headset 500 to provide the alert.

Various embodiments of the present disclosure may be implemented in digital electronic circuitry, or in computer hardware, firmware, software, or in combinations thereof. Embodiments of the present disclosure may be implemented in a computer program product tangibly embodied in a computer-readable storage device for execution by a programmable processor. The described processes may be performed by a programmable processor executing a program of instructions to perform functions by operating on input data and generating output. Embodiments of the present disclosure may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, processors receive instructions and data from a read-only memory and/or a random access memory. Generally, a computer includes one or more mass storage devices for storing data files. Such devices include magnetic disks, such as internal hard disks and removable disks, magneto-optical disks; optical disks, and solid-state disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, ASICs (application-specific integrated circuits). As used herein, the term “module” may refer to any of the above implementations.

A number of implementations have been described. Nevertheless, various modifications may be made without departing from the scope of the disclosure. Accordingly, other implementations are within the scope of the following claims.

What is claimed is:

1. Apparatus comprising:
an earpiece;
an acoustic transducer configured to generate an acoustic wave external to the earpiece;
an acoustic sensor;
a speaker disposed internal to the earpiece; and
a processor configured to cause the headset to provide an alert responsive to the acoustic sensor receiving a reflection of the acoustic wave.

2. A headset comprising the apparatus of claim 1.

3. The apparatus of claim 1, wherein:
the processor is further configured to generate one or more parameters representing at least one of
i) a distance to a reflector of the acoustic wave,
ii) a velocity of the reflector of the acoustic wave,
iii) an acceleration of the reflector of the acoustic wave, and
iv) a direction to the reflector of the acoustic wave; and
the processor is further configured to cause the apparatus to provide the alert only responsive to the one or more parameters meeting selected criteria.

4. The apparatus of claim 1, wherein:
to provide the alert, the processor is further configured to cause the speaker to generate an audible message.

5. The apparatus of claim 1, wherein:
the processor is further configured to apply active noise reduction to audio provided to the speaker; and
to provide the alert, the processor is further configured to modify the active noise reduction.

6. The apparatus of claim 1, further comprising:
a microphone configured to generate audio;
wherein, to provide the alert, the processor is further configured to provide the audio to the speaker.

7. The apparatus of claim 1, further comprising:
a port configured to allow sound into the earpiece when open, and to block sound from passing into the earpiece when closed;
wherein, to provide the alert, the processor is configured to cause the port to open.

8. The apparatus of claim 1, further comprising:
a microphone configured to generate audio;
wherein the processor is further configured to provide the alert responsive to the audio meeting selected criteria, wherein the selected criteria includes at least one of
i) whether the audio represents speech, and
ii) whether the audio represents a spoken selected keyword.

9. A method comprising:
generating, at a headset, an acoustic wave external to the headset; and
providing an alert to a user of the headset responsive to receiving a reflection of the acoustic wave.

10. The method of claim 9, further comprising:
generating one or more parameters representing at least one of
i) a distance to a reflector of the acoustic wave,
ii) a velocity of the reflector of the acoustic wave,
iii) an acceleration of the reflector of the acoustic wave, and
iv) a direction to the reflector of the acoustic wave; and
providing the alert only responsive to the one or more parameters meeting selected criteria.

11. The method of claim 9, further comprising:
generating an audible message.

12. The method of claim 9, further comprising:
modifying active noise reduction applied to audio provided to a speaker of the headset.

13. The method of claim 9, further comprising:
providing, to a speaker of the headset, audio generated by a microphone of the headset.

14. The method of claim 9, further comprising:
opening a port of the headset, wherein the port allows sound into an earpiece of the headset when open.

15. Computer-readable media embodying instructions executable by a computer disposed in a headset to perform functions comprising:
causing an acoustic transducer to generate an acoustic wave external to the headset; and
providing an alert to a user of the headset responsive to an acoustic sensor of the headset receiving a reflection of the acoustic wave.

16. The computer-readable media of claim 15, wherein the functions further comprise:
generating one or more parameters representing at least one of
i) a distance to a reflector of the acoustic wave,
ii) a velocity of the reflector of the acoustic wave,
iii) an acceleration of the reflector of the acoustic wave, and
iv) a direction to the reflector of the acoustic wave; and
providing the alert only responsive to the one or more parameters meeting selected criteria.

17. The computer-readable media of claim 15, wherein the functions further comprise:
causing a speaker of the headset to generate an audible message.

18. The computer-readable media of claim 15, wherein the functions further comprise:
modifying active noise reduction applied to audio provided to a speaker of the headset.

19. The computer-readable media of claim 15, wherein the functions further comprise:
providing, to a speaker of the headset, audio generated by a microphone of the headset.

20. The computer-readable media of claim 15, wherein the functions further comprise:
causing a port of the headset to open, wherein the port allows sound into an earpiece of the headset when open.
